(19) United States
(12) Patent Application Publication
(10) Pub. No.: US 2024/0427971 A1
(43) Pub. Date: Dec. 26, 2024

(54) SYSTEM FOR ANALYZING AIRFLOW AND AIR QUALITY AROUND VERTICAL FOREST USING COMMUTATIONAL FLUID DYNAMICS WITH TREE PARAMETERIZATION, ANALYZING METHOD USING THE SAME

(71) Applicant: PUKYONG NATIONAL UNIVERSITY INDUSTRY-UNIVERSITY COOPERATION FOUNDATION, Busan (KR)

(72) Inventors: Jae Jin KIM, Busan (KR); Geon KANG, Busan (KR)

(73) Assignee: PUKYONG NATIONAL UNIVERSITY INDUSTRY-UNIVERSITY COOPERATION FOUNDATION, Busan (KR)

(21) Appl. No.: 18/749,373

(22) Filed: Jun. 20, 2024

(30) Foreign Application Priority Data
Jun. 21, 2023 (KR) 10-2023-0079872

(51) Int. Cl. G06F 30/28; G06F 111/10; G06F 113/08

(52) U.S. Cl. CPC G06F 30/28; G06F 2111/10; G06F 2113/08

(57) ABSTRACT

Disclosed is a system for analyzing air flow and air quality around a vertical forest using a computational fluid dynamics (CFD) model based on a tree effect. The system includes: a modeling unit configured to: receive information on a width of a road, a width of a building, a building-height aspect ratio, and a building-length aspect ratio; create a step-up street canyon based on the width of the road, the width of the building, the building-height aspect ratio, and the building-length aspect ratio; to receive information about a tree height and a planting rate; and create trees on a ceiling and an outer wall of at least one building included in the step-up street canyon based on the information, thereby modeling the step-up street canyon including a vertical forest as an analysis target; a computational fluid dynamics (CFD) analysis unit configured to: set a wind inflow condition in the modeled step-up street canyon; and analyze a wind field and air quality of the modeled step-up street canyon using a computational fluid dynamics (CFD) model to which a drag effect of the tree and an air pollutant deposition effect of the tree have been applied; and a visualization unit configured to: visualize the modeled step-up street canyon in a three dimensions manner in a virtual space; and add the wind field or air quality analysis result to the visualized step-up street canyon to visualize the modeled step-up street canyon.

### CROSS-REFERENCE TO RELATED APPLICATION

This application claims a benefit under 35 U.S.C. § 119a of Korean Patent Application No. 10-2023-0079872 filed on Jun. 21, 2023, on the Korean Intellectual Property Office, the entirety of disclosure of which is incorporated herein by reference for all purposes.

### BACKGROUND

### Field

The present disclosure relates to a system and method for analyzing air flow and air quality around a vertical forest using a computational fluid dynamics (CFD) model based on a tree effect. More particularly, the present disclosure relates to a system and method for analyzing air flow and air quality around a vertical forest using a computational fluid dynamics (CFD) model based on a tree effect in which a drag effect of trees and a dry deposition effect of air pollutants on the trees are applied to a computational fluid dynamics (CFD) model to analyze an impact of a vertical forest (a building with trees and plants planted on a building outer wall and ceiling) on air flow and air quality around the vertical forest.

### Description of Related Art

As various problems arise due to fine dust, interest in creating green infrastructure such as forests and parks in urban areas is growing. A tree may provide various positive functions. For example, trees may improve air quality by absorbing and depositing air pollutants on the leaf surface, and may lower atmospheric temperature through evapotranspiration, and supply moisture to the atmosphere.

Increasing a green space within urban areas is not easy as a space within the urban areas is limited and a significant portion of the space is already used for other purposes. Recently, attempts have been made to create the green space not only on the ground but also on building rooftops, wall surfaces, and balconies in order to expand the green space in urban areas. A representative example thereof is Bosco Verticale (vertical forest) in Milan, Italy. About 800 trees and tens of thousands of plants are planted and arrange vertically on the balcony of this building (vertical forest), thereby providing about 30,000 m² of the green space on about 3,000 m² of land.

However, trees in the city, along with buildings, act as obstacles that affect air flow, so that in areas where trees are dense, air flow may be weakened and the spread of pollutants may be reduced. Therefore, the impact of trees in the urban areas on air quality and pollutant spread should be comprehensively analyzed.
Prior art literature: Patent Document 1: Korean Patent No. 10-2387251 (2022.04.12)

### SUMMARY

A purpose of the present disclosure is to provide a system and method for analyzing air flow and air quality around a vertical forest using a computational fluid dynamics (CFD) model based on a tree effect in which the system and method may apply a drag effect of trees and a dry deposition effect of air pollutants on the trees to the computational fluid dynamics (CFD) model to more accurately analyze an impact of a vertical forest (a building with trees and plants planted on a building outer wall and ceiling) on air flow and air quality around the vertical forest.

A purpose of the present disclosure is to provide a system and method for analyzing air flow and air quality around a vertical forest using a computational fluid dynamics (CFD) model based on a tree effect in which the system and method may analyze the impact of the vertical forest on the air flow and air quality around the vertical forest in urban areas and may use the analysis result to improve the wind environment and air quality in the related area.

A purpose of the present disclosure is to provide a system and method for analyzing air flow and air quality around a vertical forest using a computational fluid dynamics (CFD) model based on a tree effect in which the system and method may arrange objects such as buildings or trees to create a model, and determine the wind environment and air quality of the related area in advance based on the model, during urban planning or urban landscaping planning.

One aspect of the present disclosure provides a system for analyzing air flow and air quality around a vertical forest using a computational fluid dynamics (CFD) model based on a tree effect, the system comprising: a modeling unit configured to: receive information on a width of a road, a width of a building, a building-height aspect ratio, and a building-length aspect ratio; create a step-up street canyon based on the width of the road, the width of the building, the building-height aspect ratio, and the building-length aspect ratio; to receive information about a tree height and a planting rate; and create trees on a ceiling and an outer wall of at least one building included in the step-up street canyon based on the information, thereby modeling the step-up street canyon including a vertical forest as an analysis target; a computational fluid dynamics (CFD) analysis unit configured to: set a wind inflow condition in the modeled step-up street canyon; and analyze a wind field and air quality of the modeled step-up street canyon using a computational fluid dynamics (CFD) model to which a drag effect of the tree and an air pollutant deposition effect of the tree have been applied; and a visualization unit configured to: visualize the modeled step-up street canyon in a three dimensions manner in a virtual space; and add the wind field or air quality analysis result to the visualized step-up street canyon to visualize the modeled step-up street canyon.

In accordance with some embodiments of the system according to the present disclosure, the modeling unit is configured to model a tree-free step-up street canyon in which trees are absent on a ceiling and an outer wall of a building, wherein the computational fluid dynamics (CFD) analysis unit is configured to analyze a wind field and air quality on the tree-free step-up street canyon, wherein the visualization unit is configured to visualize the wind field and air quality analysis results on the tree-free step-up street canyon and the wind field and air quality analysis results on the step-up street canyon including the vertical forest.

In accordance with some embodiments of the system according to the present disclosure, the computational fluid dynamics (CFD) analysis unit is configured to: numerically analyze the wind field based on a governing Equation of a CFD model of a RANS (Reynolds-Averaged Navier-Stokes Equation) model; and numerically analyze the air quality based on a pollutant transport Equation.

In accordance with some embodiments of the system according to the present disclosure, the computational fluid dynamics (CFD) analysis unit configured to numerically analyzes the wind field is further configured to calculate a momentum, turbulent kinetic energy (TKE) and a turbulence kinetic energy (TKE) dissipation rate, based on a tree drag parameterized based on a leaf drag coefficient (C_{d}) as a leaf surface roughness, and a leaf area density (LAD) as an area occupied with leaves per unit volume.

In accordance with some embodiments of the system according to the present disclosure, the computational fluid dynamics (CFD) analysis unit is configured to calculate the momentum using a following Equation 4:

$${{\frac{{dU}_{i}}{dt} \vert}_{tree} = \frac{{dU}_{i}}{dt} \vert}_{org} - {n}_{c}^{3} \cdot {c}_{d} \cdot LAD \cdot {U}_{i} \cdot \vert U \vert \qquad [ Equation 4 ]$$

wherein the Equation 4 represents a relationship between a momentum Equation (tree) with a tree drag term and a momentum Equation (org) without a tree drag term,

where i is an integer, Uᵢ denote an i^{th} mean velocity component, ne denotes a fraction covered with a vertical projection of the leaves, C_{d} denotes the leaf drag coefficient as the leaf surface roughness of the tree, the LAD (Leaf Area Density) denotes an area size occupied with the leaves per unit volume, and |U| denotes a wind speed.

In accordance with some embodiments of the system according to the present disclosure, the computational fluid dynamics (CFD) analysis unit is configured to calculates the turbulence kinetic energy (TKE) using a following Equation 9:

$${{\frac{d k}{dt} \vert}_{tree} = \frac{d k}{dt} \vert}_{org} + {n}_{c}^{3} {c}_{d} LAD {\vert U \vert}^{3} - 4 {n}_{c}^{3} {c}_{d} LAD k \vert U \vert \qquad [ Equation 9 ]$$

wherein the Equation 9 represents a relationship between the turbulence kinetic energy (TKE) with the tree drag term added thereto and the turbulence kinetic energy (TKE) (org) without the tree drag term, where k denote the turbulence kinetic energy (TKE), i is an integer, Uᵢ denote an i^{th} mean velocity component, ne denotes a fraction covered with a vertical projection of the leaves, C_{d} denotes the leaf drag coefficient as the leaf surface roughness of the tree, the LAD (Leaf Area Density) denotes an area size occupied with the leaves per unit volume, and |U| denotes a wind speed.

In accordance with some embodiments of the system according to the present disclosure, the computational fluid dynamics (CFD) analysis unit is configured to calculate the turbulence kinetic energy (TKE) dissipation rate using a following Equation 11:

$${{\frac{d ε}{dt} \vert}_{tree} = \frac{d ε}{dt} \vert}_{org} + \frac{3}{2} \frac{ε}{k} {n}_{c}^{3} {c}_{d} LAD {\vert U \vert}^{3} - 6 {n}_{c}^{3} {c}_{d} LAD ε \vert U \vert \qquad [ Equation 11 ]$$

wherein the Equation 11 expresses a relationship between the turbulence kinetic energy (TKE) dissipation rate (tree) with a tree drag term added thereto and the turbulence kinetic energy (TKE) dissipation rate (org) without the tree drag term, where ε denotes the TKE dissipation rate, i is an integer, Uᵢ denote an i^{th} mean velocity component, ne denotes a fraction covered with a vertical projection of the leaves, Ca denotes the leaf drag coefficient as the leaf surface roughness of the tree, the LAD (Leaf Area Density) denotes an area size occupied with the leaves per unit volume, and |U| denotes a wind speed.

In accordance with some embodiments of the system according to the present disclosure, the computational fluid dynamics (CFD) analysis unit configured to numerically analyze the air quality is further configured to analyze the air quality by applying dry deposition in which air pollutant is deposited on the leaves of trees, using a following Equation 16:

$$\frac{\partial C}{\partial t} + {U}_{j} \frac{\partial C}{\partial t} = D \frac{{\partial }^{2} C}{\partial {x}_{j} \partial {x}_{j}} - \frac{\partial }{\partial {x}_{j}} ( \overline{{cu}_{j}} ) - LAD \cdot {V}_{d} \cdot C \qquad [ Equation 16 ]$$

where C denotes a mean concentration of a given pollutant species in air, D denotes a molecular diffusivity of the pollutant, and V_{d} denotes a dry deposition velocity, wherein C and Uⱼ represent fluctuations from respective means of C and Uᵢ, respectively, wherein −c̅u̅ⱼ̅ represents a turbulent flux of pollutants.

In accordance with some embodiments of the system according to the present disclosure, the system further comprises a verification unit configured to: apply the computational fluid dynamics (CFD) model to which an air pollutant deposition effect has been to a test model; and verify the computational fluid dynamics (CFD) model based on application result.

In accordance with some embodiments of the system according to the present disclosure, the test model is a wind-tunnel model.

Another aspect of the present disclosure provides a method for analyzing air flow and air quality around a vertical forest using a computational fluid dynamics (CFD) model based on a tree effect, the method comprising: receiving, by a modeling unit, information on a width of a road, a width of a building, a building-height aspect ratio, and a building-length aspect ratio; creating, by the modeling unit, a step-up street canyon based on the width of the road, the width of the building, the building-height aspect ratio, and the building-length aspect ratio; receiving, by the modeling unit, information about a tree height and a planting rate; creating, by the modeling unit, trees on a ceiling and an outer wall of at least one building included in the step-up street canyon based on the information, thereby modeling the step-up street canyon including a vertical forest as an analysis target; setting, by a computational fluid dynamics (CFD) analysis unit, a wind inflow condition in the modeled step-up street canyon; analyzing, by the computational fluid dynamics (CFD) analysis unit, a wind field and air quality of the modeled step-up street canyon using a computational fluid dynamics (CFD) model to which a drag effect of the tree and an air pollutant deposition effect of the tree have been applied; visualizing, by a visualization unit, the modeled step-up street canyon in a three dimensions manner in a virtual space; and adding, by the visualization unit, the wind field or air quality analysis result to the visualized step-up street canyon to visualize the modeled step-up street canyon.

In accordance with some embodiments of the method of the present disclosure, analyzing, by the computational fluid dynamics (CFD) analysis unit, the wind field and air quality of the modeled step-up street canyon includes: numerically analyzing, by the computational fluid dynamics (CFD) analysis unit, the wind field based on a governing Equation of a CFD model of a RANS (Reynolds-Averaged Navier-Stokes Equation) model; and numerically analyzing, by the computational fluid dynamics (CFD) analysis unit, the air quality based on a pollutant transport Equation.

In accordance with some embodiments of the method of the present disclosure, the method further comprises: applying, by a verification unit, the computational fluid dynamics (CFD) model to which an air pollutant deposition effect has been to a test model; and verifying, by the verification unit, the computational fluid dynamics (CFD) model based on application result.

The system and method for analyzing air flow and air quality around a vertical forest using a computational fluid dynamics (CFD) model based on a tree effect may apply a drag effect of trees and a dry deposition effect of air pollutants on the trees to the computational fluid dynamics (CFD) model to more accurately analyze an impact of a vertical forest (a building with trees and plants planted on a building outer wall and ceiling) on air flow and air quality around the vertical forest.

The system and method for analyzing air flow and air quality around a vertical forest using a computational fluid dynamics (CFD) model based on a tree effect may analyze the impact of the vertical forest on the air flow and air quality around the vertical forest in urban areas and may use the analysis result to improve the wind environment and air quality in the related area.

The system and method for analyzing air flow and air quality around a vertical forest using a computational fluid dynamics (CFD) model based on a tree effect may arrange objects such as buildings or trees to create a model, and determine the wind environment and air quality of the related area in advance based on the model, during urban planning or urban landscaping planning.

Effects of the present disclosure are not limited to the effects mentioned above, and other effects not mentioned will be clearly understood by those skilled in the art from the description below.

In addition to the above effects, specific effects of the present disclosure are described together while describing specific details for carrying out the present disclosure.

### BRIEF DESCRIPTION OF DRAWINGS

FIG. 1 is a diagram showing a configuration of a system for analyzing air flow and air quality around a vertical forest using a computational fluid dynamics (CFD) model based on tree effect according to an embodiment of the present disclosure.

FIG. 2 is a diagram schematically showing the tree and measurement location of the wind tunnel experiment performed by Huang et al. (2013).

FIG. 3 shows a table summarizing the tree leaf area density (LAD), the inflow wind speed, and the drag coefficient (C_{d}) under each scenario experiment in the wind tunnel experiment performed by Huang et al. (2013).

FIG. 4 shows a diagram showing measurements and numerical experiments performed by Huang et al. (2013), and the particle deposition efficiency on the downwind of the tree under each scenario experiment analyzed using the system according to the present disclosure.

FIG. 5 is a drawing showing a three-dimensional model of a vertical forest built in a step-up street canyon.

FIG. 6 is a diagram showing a wind field (a) obtained by the wind tunnel experiment of Addepalli and Pardyjak (2013) on a building without trees, a wind field (b) obtained by the system according to the present disclosure on a building without trees, and a wind field (c) obtained by the system according to the present disclosure on the vertical forest.

FIG. 7 is a diagram showing the turbulent kinetic energy and the vorticity of each of a building without trees and a vertical forest building as analyzed using the system of FIG. 1.

FIG. 8 is a diagram showing the wind field on the wall surface of each of the upwind building and the downwind building in each of the step-up street canyon without trees and the step-up street canyon having the vertical forest as analyzed using the system in FIG. 1.

FIG. 9 is a diagram showing the wind field based on an altitude in each of the canyon of the building without trees and the canyon having the vertical forest building as analyzed using the system in FIG. 1.

FIG. 10 is a diagram showing the three-dimensional streamline around each of a building without trees and a vertical forest building as analyzed using the system in FIG. 1.

FIG. 11 is a diagram showing a wind speed and a wind speed reduction percentage in each analysis target area under the leaf area density (LAD) scenario as analyzed using the system in FIG. 1.

FIG. 12 is a diagram showing a non-dimensional concentration field on each of the upwind and downwind wall surfaces of each of the building without trees and the vertical forest building as analyzed using the system in FIG. 1.

FIG. 13 is a diagram showing the non-dimensional concentration field based on an altitude inside each of the canyon composed of the building without trees and the canyon having the vertical forest building as analyzed using the system in FIG. 1.

FIG. 14 is a diagram showing the dimensionless concentration and the concentration reduction percentage in each analysis target area based on the leaf area density (LAD) scenario as analyzed using the system in FIG. 1.

FIG. 15 shows the concentration reduction percentage (CRDP) calculated based on only the deposition effect in each analysis target area under the leaf area density (LAD) scenario as analyzed using the system in FIG. 1, and the concentration reduction percentage (CRDP) calculated based on the deposition and drag effects in each analysis target area under the leaf area density (LAD) scenario as analyzed using the system in FIG. 1.

FIG. 16 shows the three-dimensional non-dimensional concentration field around the building without trees and the vertical forest building as analyzed using the system in FIG. 1, and the area where the concentration is improved (CRAD>0.0%) and the area where the concentration is deteriorated (CRAD<0.0%).

FIG. 17 is a flowchart for illustrating for analyzing air flow and air quality around a vertical forest using a computational fluid dynamics (CFD) model based on tree effect according to an embodiment of the present disclosure.

### DETAILED DESCRIPTIONS

Advantages and features of the present disclosure, and a method of achieving the advantages and features will become apparent with reference to embodiments described later in detail together with the accompanying drawings. However, the present disclosure is not limited to the embodiments as disclosed under, but may be implemented in various different forms. Thus, these embodiments are set forth only to make the present disclosure complete, and to completely inform the scope of the present disclosure to those of ordinary skill in the technical field to which the present disclosure belongs, and the present disclosure is only defined by the scope of the claims.

The terminology used herein is directed to the purpose of describing particular embodiments only and is not intended to be limiting of the present disclosure. As used herein, the singular constitutes “a” and “an” are intended to include the plural constitutes as well, unless the context clearly indicates otherwise. It will be further understood that the terms “comprise”, “comprising”, “include”, and “including” when used in this specification, specify the presence of the stated features, integers, operations, elements, and/or components, but do not preclude the presence or addition of one or more other features, integers, operations, elements, components, and/or portions thereof.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, a system and method for analyzing air flow and air quality around a vertical forest using a computational fluid dynamics (CFD) model based on a tree effect according to the present disclosure will be described.

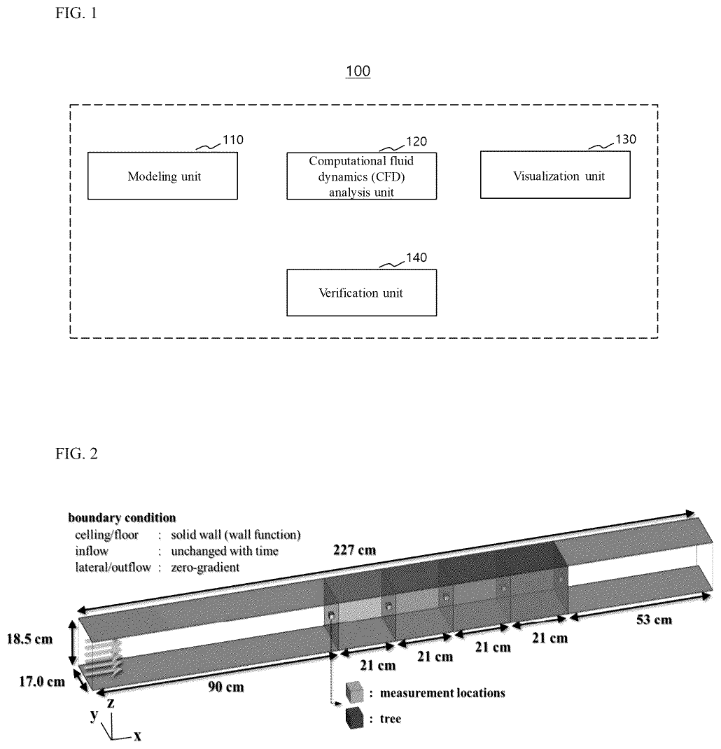

FIG. 1 is a diagram showing a configuration of a system for analyzing air flow and air quality around a vertical forest using a computational fluid dynamics (CFD) model based on the tree effect according to an embodiment of the present disclosure.

Referring to FIG. 1, a system 100 for analyzing air flow and air quality around a vertical forest using a computational fluid dynamics (CFD) model based on the tree effect includes a modeling unit 110, a computational fluid dynamics (CFD) analysis unit 120, a visualization unit 130, and a verification unit 140.

The system 100 for analyzing the air flow and air quality around the vertical forest using the computational fluid dynamics (CFD) model based on the tree effect may apply the tree effect to the computational fluid dynamics (CFD) model to more accurately analyze the air flow and air quality around the vertical forest in urban areas and may convert the analyzing result into a graph. In one embodiment, the system 100 for analyzing air flow and air quality around a vertical forest using a computational fluid dynamics (CFD) model based on the tree effect may be implemented based on a program executed on a computing device (e.g., computer, PC, laptop, tablet, etc.). In another embodiment, the system 100 for analyzing air flow and air quality around a vertical forest using a computational fluid dynamics (CFD) model based on the tree effect may be implemented using a hardware module.

The modeling unit 110 may set a road width, a building width, a building-height aspect ratio, and a building-length aspect ratio to create a step-up street canyon. For example, the modeling unit 100 may receive the width of the road, the width of the building, the building-height aspect ratio, and the building-length aspect ratio under the user's control, and may generate the step-up street canyon as an analysis target based on the width of the road, the width of the building, the building-height aspect ratio, and the building-length aspect ratio. The step-up street canyon refers to a street canyon where the upwind building height is smaller than the downwind building height, and refers to a type of a building group commonly present in urban areas with dense buildings.

For example, the modeling unit 110 may set the width of the street canyon (or the width of the road within the street canyon) to 32 m (S=32 m), the upwind building height to 57.6 m (1.8 S), the downwind building height to 96 m (3 S), and the length of each building to 96 m (3 S) under the user's control and create the step-up street canyon based on the settings.

In another embodiment, the modeling unit 110 may set the width of the street canyon (or, the width of the road within the street canyon) to 32 m (S=32 m), an along-wind building length (or, the width of the building) to 32 m (Lₐ=32 m), and the downwind building height to 96 m (H_{d}=96 m), the upwind building height to 32 m or 57.6 m (Hᵤ=32 m or 57.6 m), and may set the along-canyon length of the building (Lc) such that the along-canyon length of the building (Lc) increases from 16 m to 128 m by 16 m, and may create the step-up street canyon based on the settings.

The building-height aspect ratio may be set to one of 0.33 and 0.6 (Hᵤ/H_{d}=0.33 and 0.60). When the building-height aspect ratio is 0.33, the SSC is defined as a shallow step-up street canyon. When the building-height aspect ratio is 0.6, the SSC is defined as a deep step-up street canyon. The building-length aspect ratio may be set to one of 0.5, 1.0, 1.5, 2.0, 2.5, 3.0, 3.5, and 4.0. (Lc/S=0.5, 1.0, 1.5, 2.0, 2.5, 3.0, 3.5, and 4.0).

The modeling unit 110 may generate various types of street canyons as analysis targets under user control, and may generate various types of street canyons depending on implementation examples. In another embodiment, the modeling unit 110 may receive surface lateral boundary (SLB) information of an analysis target area, generate terrain, structures, and trees of the analysis target area, and model the analysis target area based on the surface lateral boundary (SLB) information.

The modeling unit 110 may receive tree height and planting rate information under user control, and create the tree on the ceiling and outer wall of at least one building included in the step-up street canyon to model the analysis target step-up street canyon including the vertical forest.

The modeling unit 110 may model the analysis target area (e.g., the step-up street canyon) within a uniform grid system. In this regard, each element in the uniform grid system may have preset dimensions in x, y, and z directions, respectively. In other words, the step-up street canyon may be modeled in a three-dimensional space expressed as a uniform grid system. In one embodiment, the modeling unit 110 may model an analysis target area in a three-dimensional space expressed as the uniform grid system where the element has dimensions 1.6 m in the x, y, and z directions, and the total numbers of elements are 360, 260, and 180 in the x, y, and z directions, respectively.

For example, when the height of the tree is 3.2 m and the planting rate is 50%, the modeling unit 110 may model the step-up street canyon having the building having the ceiling and outer wall on which the trees of the height of 3.2 m are planted at the planting rate to 50%. In one embodiment, the modeling unit 110 may create the trees on the ceiling and outer wall of all buildings included in the step-up street canyon, and may create the trees on the ceiling and outer wall of at least one selected building.

The computational fluid dynamics (CFD) analysis unit 120 may set wind inflow conditions to be applied to the modeled step-up street canyon, and may analyze a wind field and an air quality of the step-up street canyon modeled using the computational fluid dynamics (CFD) model to which the tree drag and air pollutant deposition effects affected by the tree have been applied.

Hereinafter, a process in which the computational fluid dynamics (CFD) analysis unit 120 analyzes the wind field of the step-up street canyon modeled using a computational fluid dynamics (CFD) model to which the tree drag effect has been applied.

The wind inflow conditions may be set as follows. A condition of the wind flowing into the modeled analysis target area may include: an initial wind velocity (U, V, W), turbulence kinetic energy (TKE) (k), and turbulence kinetic energy (TKE) dissipation rate (ε).

The initial wind velocity may be set based on a following Equation 1, the turbulence kinetic energy (TKE) may be set based on a following Equation 2, and the turbulence kinetic energy (TKE) dissipation rate may be set based on a following Equation 3.

$$\begin{matrix}U ( 𝓏 ) = {{U}_{B} ( \frac{𝓏}{{H}_{B}} )}^{\text{?}} , \\ V ( 𝓏 ) = 0 , \\ W ( 𝓏 ) = 0 ,\end{matrix} \qquad [ Equation 1 ]$$

$$k ( z ) = \frac{u {\text{?}}^{2}}{{c}_{μ}^{1 / 2}} {( 1 - \frac{𝓏}{δ} )}^{2} \qquad [ Equation 2 ]$$

$$ε ( 𝓏 ) = \frac{{c}_{μ}^{3 / 4} {k}^{3 / 2}}{κ 𝓏} \qquad [ Equation 3 ]$$

$$\text{?} \text{indicates text missing or illegible when filed}$$

where U_{B} denotes the wind speed at the downwind building, H_{B} denotes the height of the downwind building, α denotes the power-law exponent, u* denotes the friction velocity, δ denotes the boundary-layer depth, κ denotes the von-Karman Constant, and C_{μ} denotes an empirical constant. The above values may be set as values input under the user's control based on the analysis conditions. For example, in the RNG k-ε (epsilon) turbulence scheme, the wind speed (U_{B}) may be set to 4.32 m s⁻¹ at a height of 96 m (H_{B}=96) in the z-axis. C_{μ} may be set to 0.09, u* may be to 0.26 m s⁻¹, δ may be set to 1,000 m, and κ may be set to 0.4. The above values are merely examples and may be set to vary depending on the analysis conditions.

In one embodiment, the computational fluid dynamics (CFD) analysis unit 120 applies the tree drag effect to the computational fluid dynamics (CFD) model based on a RANS (Reynolds-Averaged Navier-Stokes Equation) model to numerically analyze the wind field in the target area. The computational fluid dynamics (CFD) analysis unit 120 applies the pollutant transport Equation to the computational fluid dynamics (CFD) model to numerically analyze the air quality

The governing Equation system of the CFD model based on the RANS model is solved in a staggered grid system using the finite volume method and aa SIMPLE (Semi-Implicit Method for Pressure-Linked Equation) algorithm. The wind field is analyzed based on the k-ε turbulent scheme based on a renormalization group (RNG) theory. For example, the computational fluid dynamics (CFD) analysis unit 120 may analyze a wind streamline, a dimensionless normalized vorticity, a vertical streamline, a velocity field, vortex and recirculation areas, stagnation-point height of wind flow, and a maximum downdraft, etc. in the analysis target area using the CFD model based on the RANS model. In one embodiment, the computational fluid dynamics (CFD) analysis unit 120 may be configured to analyze the wind field for 3600 seconds at a time interval of 0.5s.

In one embodiment, the computational fluid dynamics (CFD) analysis unit 120 may calculate a momentum, the turbulence kinetic energy (TKE), and the turbulence kinetic energy (TKE) dissipation rate, based on the tree drag parameterized based on a leaf drag coefficient (Ca, leaf surface roughness) of the tree and a leaf area density (LAD) of the tree (the LAD refers to an area size occupied with aa leaf per unit volume). In other words, the computational fluid dynamics (CFD) analysis unit 120 may apply an air pressure loss due to the tree to the computational fluid dynamics (CFD) model based on the RANS model. To this end, the computational fluid dynamics (CFD) analysis unit 120 may analyze the wind field of the analysis target area by adding the tree drag term to the momentum, the turbulence kinetic energy (TKE), and the TKE dissipation rate (dissipation rates). The leaf drag coefficient (C_{d}) and the leaf area density (LAD) values may be set to values input under user control based on the analysis conditions. For example, the leaf drag coefficient (C_{d}) may be set to 0.2, and the leaf area density (LAD) may be set to a range from 0.5 m² m⁻³ to 2.0 m² m⁻³ by 0.5 m² m⁻³.

A following Equation 4 represents a relationship between a momentum Equation (tree) with the tree drag term and a momentum Equation (org) without the tree drag term, and a following Equation 5 represents a momentum Equation without the tree drag term. I

$${{\frac{{dU}_{i}}{dt} \vert}_{tree} = \frac{{dU}_{i}}{dt} \vert}_{org} - {n}_{2}^{3} \cdot {c}_{d} \cdot LAD \cdot {U}_{i} \cdot \vert U \vert \qquad [ Equation 4 ]$$

$$\begin{matrix}\frac{\partial {U}_{i}}{\partial t} + {U}_{j} \frac{\partial {U}_{i}}{\partial {x}_{j}} = - \frac{1}{ρ} \frac{\partial {P}^{*}}{\partial {x}_{i}} + v \frac{{\partial }^{2} {U}_{i}}{\partial {x}_{j} \partial {x}_{j}} - \frac{\partial }{\partial {x}_{j}} ( \tilde{{𝓊}_{i} {𝓊}_{j}} ) & \frac{\partial {U}_{j}}{\partial {x}_{j}}\end{matrix} = 0 \qquad [ Equation 5 ]$$

where χᵢ denotes an i^{th} Cartesian coordinate (i is an integer), Uᵢ denotes i^{th} mean velocity component, P* denotes a pressure difference from a reference value, and ρ denotes the air density, v denotes a kinematic viscosity (a viscosity of the fluid divided by a density the fluid under the same temperature condition), and μᵢ denotes a fluctuation from the i^{th} mean velocity component.

Reynolds stresses in the Equation 5 may be parameterized based on a following Equation 6.

$$\tilde{- {𝓊}_{i} {𝓊}_{j}} = {K}_{m} ( \frac{\partial {U}_{i}}{\partial {x}_{j}} + \frac{\partial {U}_{j}}{\partial {x}_{j}} ) - \frac{2}{3} {δ}_{ij} k . \qquad [ Equation 6 ]$$

where Kₘ denotes the turbulent diffusivity, κ denotes the turbulent kinetic energy (TKE), and δᵢⱼ denotes the Kronecker delta value.

The turbulent diffusion rate Km in the above Equation 6 may be expressed based on a following Equation 7.

$${K}_{m} = {C}_{μ} \frac{{k}^{2}}{ε} , \qquad [ Equation 7 ]$$

where ε represents the TKE dissipation rate, and C_{μ} represents the empirical constant in the RNG k-ε turbulent closure scheme. In one embodiment, C_{μ} is assumed to be set to 0.0845.

The tree drag term of the momentum Equation in the above Equation 4 may be expressed based on a following Equation 8.

$$- {n}_{c}^{3} \cdot {c}_{d} \cdot LAD \cdot {U}_{i} \cdot \vert U \vert \qquad [ Equation 8 ]$$

where ne denotes a fraction covered with a vertical projection of the leaves, Ca denotes the leaf drag coefficient that represents the leaf surface roughness of the tree, and the LAD (Leaf Area Density) refers to the area size occupied with the leaves per unit volume, and |U| denotes a wind speed. The friction force, the leaf drag coefficient, the leaf area density, etc. may vary depending on the type of the tree and may be the predetermined values or may be set to vary depending on the type of the tree included in the analysis target area.

A following Equation 9 represents a relationship between the turbulence kinetic energy (TKE) (turbulent kinetic energy Equation) (tree) with the tree drag term added thereto and the turbulence kinetic energy (TKE) (org) without the tree drag term. A following Equation 10 is an expression representing the turbulence kinetic energy (TKE) (org) without the tree drag term.

A following Equation 11 expresses a relationship between the turbulence kinetic energy (TKE) dissipation rate (TKE dissipation rates) (tree) with a tree drag term added thereto and the turbulence kinetic energy (TKE) dissipation rate (org) without the tree drag term. A following Equation 12 is an expression that represents the turbulence kinetic energy (TKE) dissipation rate (org) without the tree drag term. In the RNG κ-ε turbulent closure scheme, a TKE prognostic Equation may be expressed based on the following Equation 9, and a TKE dissipation rate prognostic Equation may be expressed based on a following Equation 11.

$${{\frac{dk}{dt} \vert}_{tree} = \frac{dk}{dt} \vert}_{org} + {n}_{2}^{3} {c}_{d} LAD {\vert U \vert}^{3} - 4 {n}_{c}^{3} {c}_{d} {LAD}_{k} \vert U \vert \qquad [ Equation 9 ]$$

$$\frac{\partial k}{\partial t} + {U}_{j} \frac{\partial k}{\partial {x}_{j}} = - \tilde{{𝓊}_{i} {𝓊}_{j}} \frac{\partial {U}_{i}}{\partial {x}_{j}} + \frac{\partial }{\partial {x}_{j}} ( \frac{{K}_{m}}{{σ}_{k}} \frac{\partial k}{\partial {x}_{j}} ) - ε \qquad [ Equation 10 ]$$

$${{\frac{d ε}{dt} \vert}_{tree} = \frac{d ε}{dt} \vert}_{org} + \frac{3}{2} \frac{ε}{k} {n}_{c}^{3} {c}_{d} LAD {\vert U \vert}^{3} - 6 {n}_{c}^{3} {c}_{d} LAD ε \vert U \vert \qquad [ Equation 11 ]$$

$$\frac{\partial ε}{\partial t} + {U}_{j} \frac{\partial ε}{\partial {x}_{j}} = - {C}_{ε 1} \frac{ε}{k} \tilde{{𝓊}_{i} {𝓊}_{j}} \frac{\partial {U}_{i}}{\partial {x}_{j}} + \frac{\partial }{\partial {x}_{j}} ( \frac{{K}_{m}}{{σ}_{ε}} \frac{\partial k}{\partial {x}_{j}} ) - {C}_{ε 2} \frac{{ε}^{2}}{k} - {R}_{s} \qquad [ Equation 12 ]$$

A strain rate (Rₛ) in the above Equation 12 may be expressed based on a following Equation 13.

$$\begin{matrix}{R}_{S} = \frac{{C}_{μ} {η}^{3} ( 1 - η / {η}_{0} ) {ε}^{2}}{( 1 + {β}_{0} {η}^{3} ) k} \\ η = \frac{k}{ε} {⌊ ( \frac{\partial {U}_{i}}{\partial {x}_{j}} + \frac{\partial {U}_{j}}{\partial {x}_{i}} ) \frac{\partial {U}_{i}}{\partial {x}_{j}} ⌋}^{1 / 2}\end{matrix} \qquad [ Equation 13 ]$$

where C_{ε1}, C_{ε2}, σₖ, σ_{ε}, η₀, and β₀ are empirical constants and may be set to vary under the user control depending on the analysis conditions. For example, the values may be set as follows.

(C_{ε1}, C_{ε2}, σₖ, σ_{ε}, η₀, and β₀=1.42, 1.68, 0.7179, 0.7179, 4.377, and 0.012)

The remaining variables have been defined in the Equations as set forth above.

The tree drag term in the turbulence kinetic energy (TKE) Equation in the above Equation 9 may be expressed based on a following Equation 14.

$${n}_{c}^{3} {c}_{d} LAD {\vert U \vert}^{3} - 4 {n}_{c}^{3} {c}_{d} {LAD}_{k} \vert U \vert \qquad [ Equation 14 ]$$

where n_{c} denotes a fraction covered with a vertical projection of the leaves, C_{d} denotes the leaf drag coefficient that represents the leaf surface roughness of the tree, and the LAD (Leaf Area Density) refers to the area size occupied with the leaves per unit volume, and |U| denotes a wind speed. The friction force, the leaf drag coefficient, the leaf area density, etc. may vary depending on the type of the tree, and may be the predetermined values, or may be set to vary depending on the type of the tree included in the analysis target area.

The tree drag term in the turbulence kinetic energy (TKE) dissipation rate Equation in the above Equation 11 may be expressed based on a following Equation 15.

$$\frac{3}{2} \frac{ε}{k} {n}_{c}^{3} {c}_{d} LAD {\vert U \vert}^{3} - 6 {n}_{c}^{3} {c}_{d} LAD ε \vert U \vert \qquad [ Equation 15 ]$$

where n_{c} denotes a fraction covered with a vertical projection of the leaves, C_{d} denotes the leaf drag coefficient that represents the leaf surface roughness of the tree, and the LAD (Leaf Area Density) refers to the area size occupied with the leaves per unit volume, and |U| denotes a wind speed. The friction force, the leaf drag coefficient, the leaf area density, etc. may vary depending on the type of the tree, and may be the predetermined values, or may be set to vary depending on the type of the tree included in the analysis target area.

Hereinafter, a process in which the computational fluid dynamics (CFD) analysis unit 120 analyzes the air quality of the step-up street canyon modeled using the computational fluid dynamics (CFD) model to which the air pollutant deposition effect of the tree is applied.

The computational fluid dynamics (CFD) analysis unit 120 may apply a dry deposition in which air pollutant is deposited on the leaves of the tree to the computational fluid dynamics (CFD) model based on the RANS model to numerically analyze the air quality based on the pollutant transport Equation. For example, the computational fluid dynamics (CFD) analysis unit 120 may numerically analyze a concentration field of the remaining pollutants excluding the pollutants dry deposited on the tree based on the pollutant transport Equation.

A following Equation 16 represents the pollutant transport Equation with the dry deposition applied thereto.

$$\frac{\partial C}{\partial t} + {U}_{j} \frac{\partial C}{\partial t} = D \frac{{\partial }^{2} C}{\partial {x}_{j} \partial {x}_{j}} - \frac{\partial }{\partial {x}_{j}} ( \overline{c {𝓊}_{j}} ) - LAD \cdot {V}_{d} \cdot C \qquad [ Equation 16 ]$$

where C denotes a mean concentration of a given pollutant species in air, D denotes a molecular diffusivity of the pollutant, and V_{d} denotes a dry deposition velocity. C and Uⱼ represent fluctuations from respective means of C and Uᵢ, respectively. −c̅u̅ⱼ̅ represents a turbulent flux of pollutants and may be expressed based on a following Equation 17.

$$- \overline{c {𝓊}_{j}} = {K}_{c} \frac{{\partial }^{2} C}{\partial {x}_{j}} . \qquad [ Equation 17 ]$$

where K_{c} represents an vortex diffusivity of the pollutant concentration. K_{c} may be determined based on the vortex diffusivity momentum (vₜ) value and the turbulent Schmidt number (Sct).

The vortex diffusivity momentum (vₜ) value may be expressed based on the following Equation 18.

$${v}_{t} = {C}_{μ} {k}^{2} / ε \qquad [ Equation 18 ]$$

In one embodiment, Cu may denote an empirical constant of the RNG k-ε turbulent closure scheme and be set to 0.0845. K denotes the turbulence kinetic energy (TKE), ε denotes the TKE dissipation rate (dissipation rates), and the turbulent Schmidt number (Sct) may be set to 0.9.

The visualization unit 130 visualizes the analysis target area modeled in the modeling unit 110 in a three dimensions manner in a virtual space, and may add the wind field or the air quality analysis result as calculated by the computational fluid dynamics (CFD) analysis unit 120 to the visualized analysis target area to visualize the analysis target area.

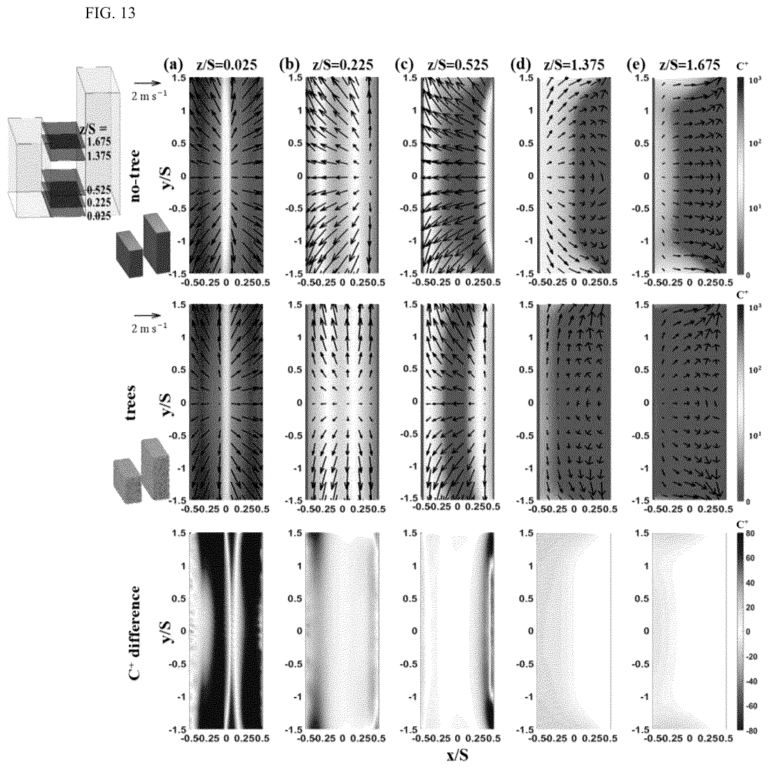

In one embodiment, the visualization unit 130 may visualize simultaneously or sequentially the wind field analysis result and the air quality analysis result on the analysis target area (e.g., the step-up street canyon) without trees and the wind field analysis result and the air quality analysis result on the analysis target area (e.g., the step-up street canyon) including the vertical forest. The modeling unit 110 may model the step-up street canyon without trees on the ceiling and outer wall of the building, and the computational fluid dynamics (CFD) analysis unit 120 may analyze the wind field and air quality on the step-up street canyon without the trees. For example, the computational fluid dynamics (CFD) analysis unit 120 may analyze the wind field using Equations without the tree drag terms in the above Equation 4, Equation 9, and Equation 11 and may analyze the air quality using the Equation without the leaf area density (LAD) term and the dry deposition velocity (V_{d}) term in FIG. 13.

In one embodiment, the system 100 for analyzing the air flow and air quality around the vertical forest using the computational fluid dynamics (CFD) model based on the tree effect may further include a verification unit 140 that verifies the computational fluid dynamics (CFD) model by applying the computational fluid dynamics (CFD) model to which the air pollutant deposition effect is applied to the test model. In one embodiment, the test model may correspond to a wind-tunnel model.

In another embodiment, the computational fluid dynamics (CFD) model to which the air pollutant deposition effect is applied may be verified using verification means provided in another system. The system 100 for analyzing the air flow and air quality around the vertical forest using the computational fluid dynamics (CFD) model based on the tree effect may not include the verification unit 140. The user stores the computational fluid dynamics (CFD) model whose performance exceeds a preset accuracy into the system 100 for analyzing air flow and air quality around the vertical forest using the computational fluid dynamics (CFD) model based on the tree effect. The system 100 for analyzing air flow and air quality around the vertical forest may analyze the wind field and the air quality using the stored computational fluid dynamics (CFD) model.

Hereinafter, the system 100 for analyzing air flow and air quality around a vertical forest using a computational fluid dynamics (CFD) model based on the tree effect in FIG. 1 will be described using a visualized analysis example.

FIG. 2 is a diagram schematically showing the tree and measurement location of the wind tunnel experiment performed by Huang et al. (2013).

Referring to FIG. 2, Huang et al. (2013) used a wind-tunnel model with a length of 227 cm, width of 17 cm, and height of 18.5 cm as a test model, and placed a tree in the center of the wind tunnel and conducted an experiment. Measuring devices were installed at a total of 5 points arranged by 21 cm spacing on the downwind of the tree, and the flow at the inlet was designed to be constant. Pollutant particles are transported from the inlet. When particles pass from the inlet through the wind tunnel and pass through the tree, the concentration of pollutant decreases due to the dry deposition of the tree, and the measuring device measures the concentration. The verification unit 140 may set the verification conditions and the test model for verification of the computational fluid dynamics (CFD) model to be identical with the wind tunnel experiment conditions and the test model according to Huang et al. (2013). The verification unit 140 may calculate the similarity between the results analyzed through the computational fluid dynamics (CFD) model and the results measured via Huang et al. (2013)'s wind tunnel experiment, and may verify the accuracy of the computational fluid dynamics (CFD) model based on the similarity. In one embodiment, the computational fluid dynamics (CFD) model verified as having the accuracy equal to or higher than a preset accuracy by the verification unit 140 may be applied to the system 100 for analyzing the air flow and air quality around the vertical forest using the computational fluid dynamics (CFD) model based on the tree effect.

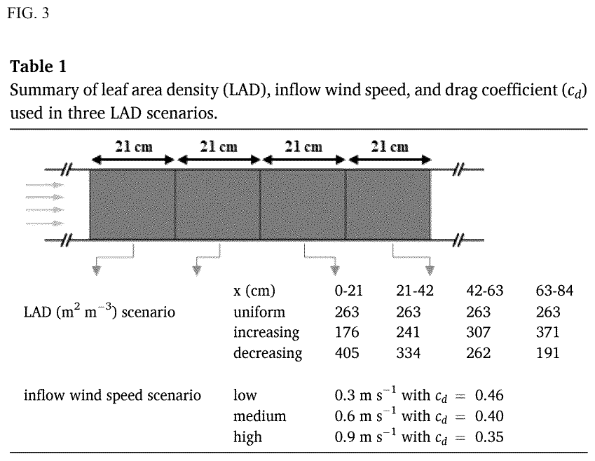

Huang et al. (2013) performed verification on three conditions: the leaf area density (LAD) of trees planted in a wind tunnel is i) constant, ii) increases, and iii) decreases as a position is closer to the downwind. Furthermore, Huang et al. (2013) performed verification on three conditions: the air flow velocity of the wind tunnel inlet is 0.3 ms⁻¹, 0.6 ms⁻¹, and 0.9 ms⁻¹, respectively under each leaf area density scenario condition (constant, increase, decrease). That is, Huang et al. (2013) performed the verification on the total 9 scenarios. FIG. 3 shows a table summarizing the tree leaf area density (LAD), the inflow wind speed, and the drag coefficient (C_{d}) under each scenario experiment in the wind tunnel experiment performed by Huang et al. (2013).

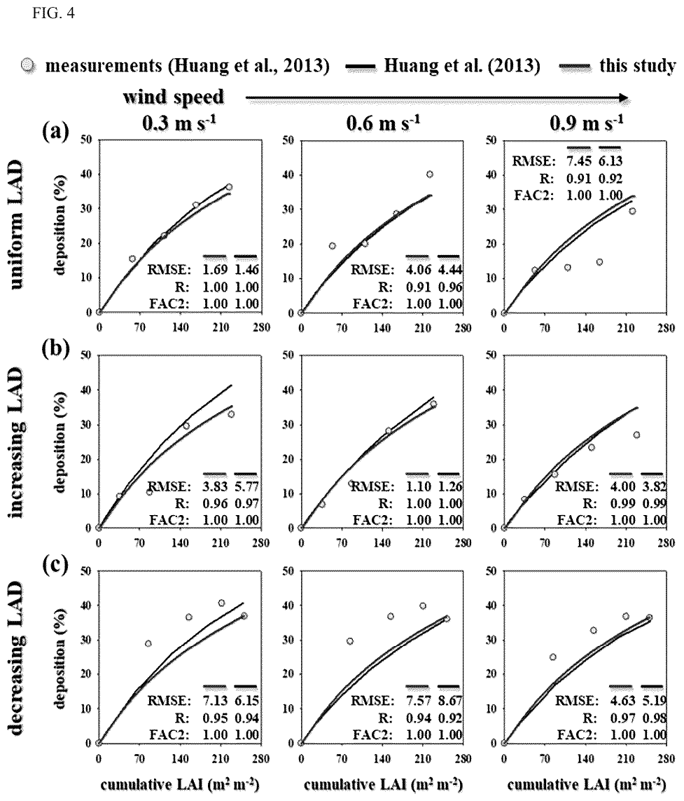

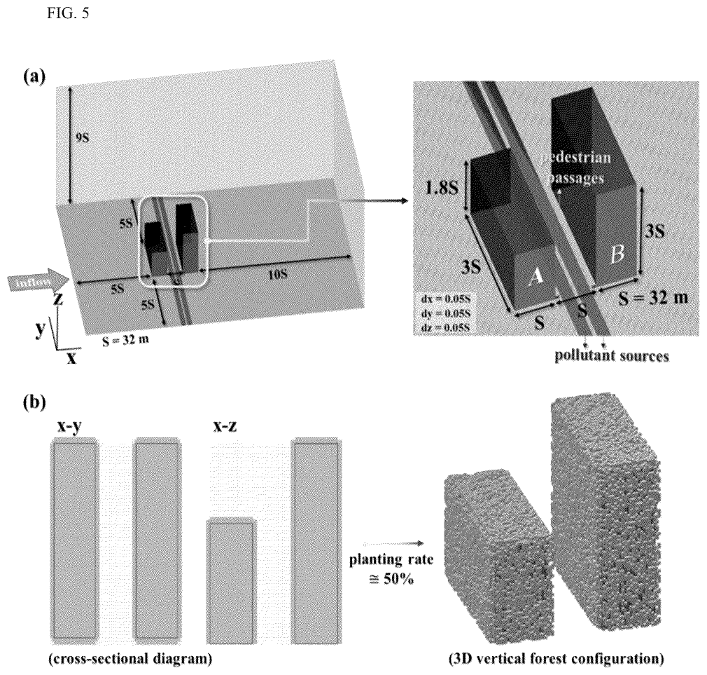

FIG. 4 shows a diagram showing measurements and numerical experiments performed by Huang et al. (2013), and the particle deposition efficiency on the downwind of the tree under each scenario experiment analyzed using the system according to the present disclosure.

Referring to FIG. 4, FIG. 4 shows a diagram showing measurements and numerical experiments performed by Huang et al. (2013), and the particle deposition efficiency on the downwind of the tree under each scenario experiment analyzed using the system according to the present disclosure. Referring to FIG. 4, it may be identified that the results calculated using the system according to the present disclosure are similar to the wind tunnel experimental measurement results of Huang et al. (2013). Furthermore, it may be identified that based on a comparison between the results calculated using the system according to the present disclosure and the wind tunnel experimental measurement results of Huang et al. (2013), the performance of the system according to the present disclosure is similar to that of Huang et al. (2013).

FIG. 5 is a diagram showing an example of a three-dimensional model of a vertical forest built in a step-up street canyon.

Referring to FIG. 5, the street canyon created in the modeling unit 110 may be embodied as a step-up street canyon in which the upwind building height is relatively smaller and the downwind building height is relatively larger. The step-up street canyon may be designed such that the width of the canyon is 32 m(S), the upwind building height is set to 57.6 m (1.8 S), the downwind building height is set to 96 m (3 S), and the length of the building is set to 96 m (3 S). In one embodiment, the step-up street canyon may be designed such that the pollutant may be discharged from the canyon center along the road. In one embodiment, the street canyon may be created in a three-dimensional space in the grid system where the element size of the grid is 1.6 m in each of the x, y, and z directions, and the total numbers of elements in the grid are 360, 260, and 180 in the x, y, and z directions, respectively.

In one embodiment, the modeling unit 110 may create at most 3.2 m tall trees at a planting rate of 50% on the ceiling and outer wall of the building included in the step-up street canyon. In one embodiment, the drag coefficient (C_{d}) of the leaf may be set to 0.2, and the leaf area density (LAD) may be set to a range from 0.5 m² m⁻³ to 2.0 m² m⁻³ by 0.5 m² m⁻³. The deposition velocity (Vd) of the tree may be set to a range from 0.0 cm s⁻¹ to 3.0 cm s⁻¹ by 0.2 cm s⁻¹.

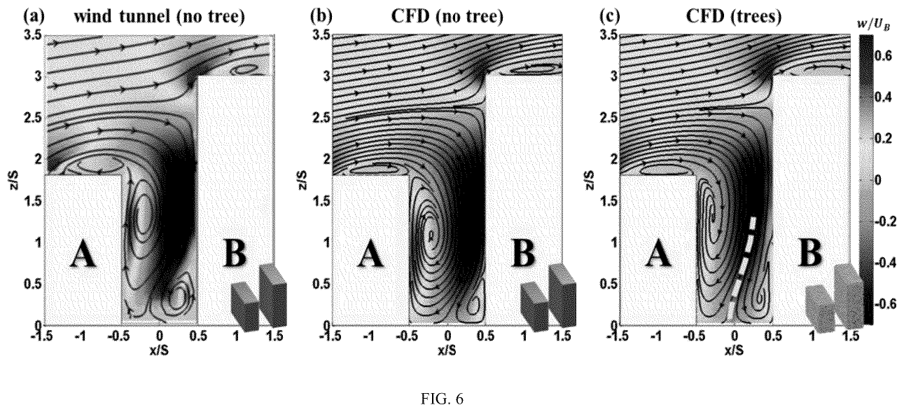

FIG. 6 is a diagram showing a wind field (a) obtained by the wind tunnel experiment of Addepalli and Pardyjak (2013) on a building without trees, a wind field (b) obtained by the system according to the present disclosure on a building without trees, and a wind field (c) obtained by the system according to the present disclosure on the vertical forest.

Referring to FIG. 6, the wind field analysis results on the step-up street canyon composed of the buildings without trees (b) and the wind tunnel experiment results (a) conducted by Addepalli and Pardyjak (2013) may be compared with each other. It was numerically simulated such that the wind field (b) of the step-up street canyon without trees as analyzed by the system 100 for analyzing the air flow and air quality around a vertical forest using the computational fluid dynamics (CFD) model in accordance with the present disclosure was similar to the wind field (a) obtained by the wind tunnel experiment of Addepalli and Pardyjak (2013) on the building without trees in terms of the air flow pattern and a dimensionless vertical velocity component. Based on a comparing result between the wind field (c) of the step-up street canyon including the vertical forest planted with the trees and the wind field (a) obtained by the wind tunnel experiment of Addepalli and Pardyjak (2013) on the building without trees in terms of the air flow pattern, it may be identified that in the step-up street canyon including the vertical forest, the descending (ascending) flow along the wall surface of the downwind (upwind) building is reduced by the tree drag effect, and the magnitude and the location of the primary vortex and secondary vortex inside the canyon change.

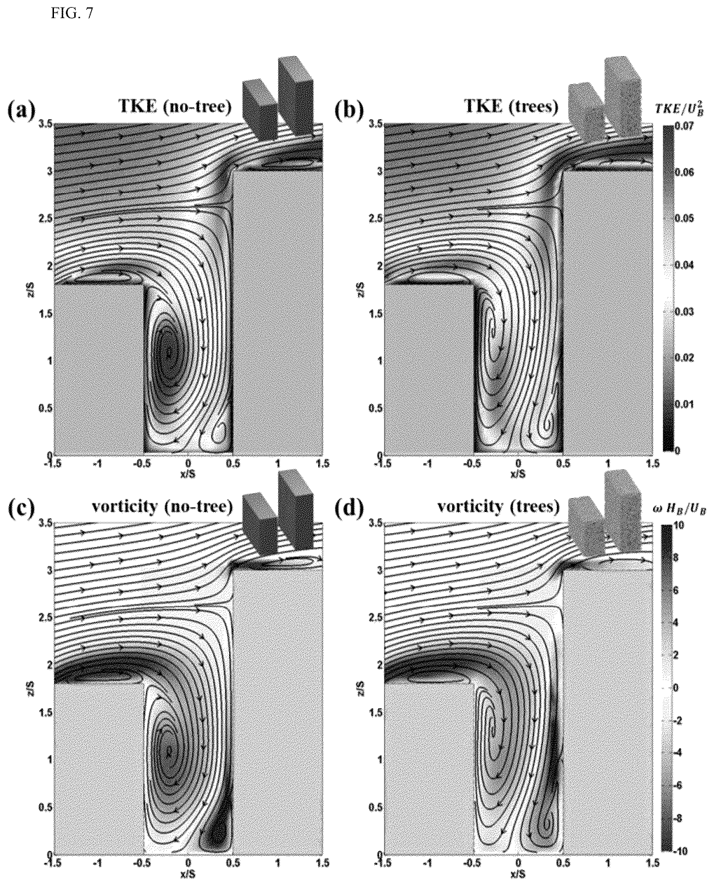

FIG. 7 is a diagram showing the turbulent kinetic energy and the vorticity of a building without trees and a vertical forest building as analyzed using the system in FIG. 1.

FIG. 7 shows respectively the results of analyzing the turbulent kinetic energy (TKE) (a) and the vorticity (c) on the step-up street canyon composed of buildings without trees, and the results of analyzing the turbulent kinetic energy (b) and the vorticity (d) on the step-up street canyon including the vertical forest planted with trees.

Referring to FIG. 7, it may be identified that the air flow is weakened near the wall surface of the building due to the drag effect of the tree, resulting in decrease in TKE at the center of the primary vortex and on the wall surface on the upwind building. It may be identified that in the step-up street canyon including the vertical forest, the magnitude of the primary vorticity is lowered due to reduced TKE and negative vorticity. On the other hand, it may be identified that near the wall surface of the downwind building, TKE increases due to an increase in a velocity gradient, an area of a positive vorticity expands, and the magnitude of the secondary vortex increases vertically.

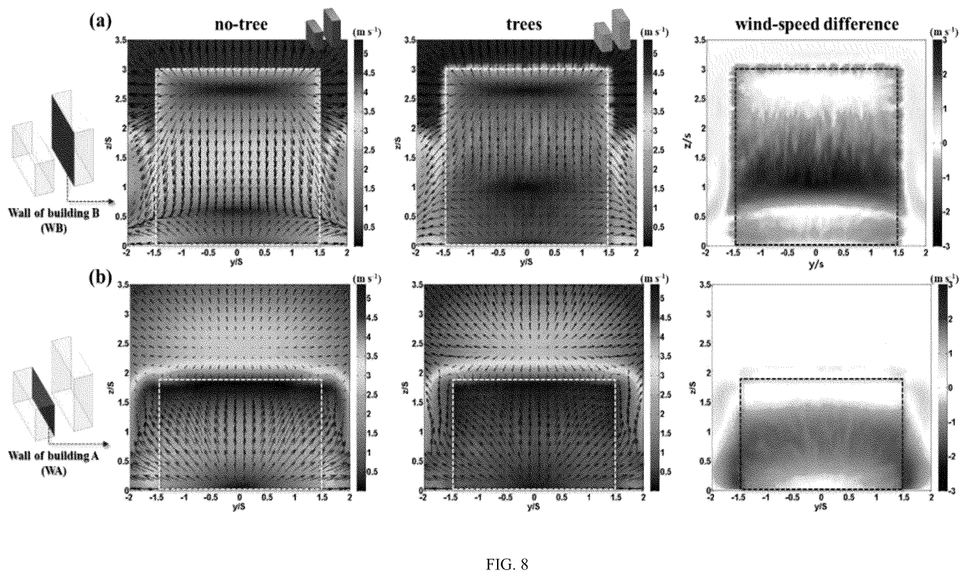

FIG. 8 is a diagram showing the wind field on the wall surface of each of the upwind building and the downwind building in each of the step-up street canyon without trees and the step-up street canyon having the vertical forest as analyzed using the system in FIG. 1.

FIG. 8 shows the wind field (a) on the downwind wall surface and the wind field (b) on the upwind wall surface, respectively.

Referring to FIG. 8, it may be identified that in the building without a tree in the step-up street canyon, the upward flow hits the upwind wall surface at about z/S=2.6 and diverges in all directions. It may be identified that the descending flow along the building meets the rising airflow caused by the secondary vortex near the ground, thereby generating a stagnation point at about z/S=0.5. It may be identified that in the vertical forest building in the step-up street canyon, the magnitude of the secondary vortex increases vertically and the stagnation point increases up to z/S=1.0. It may be identified that the wind speed is lowered near the wall surface due to the presence of the trees.

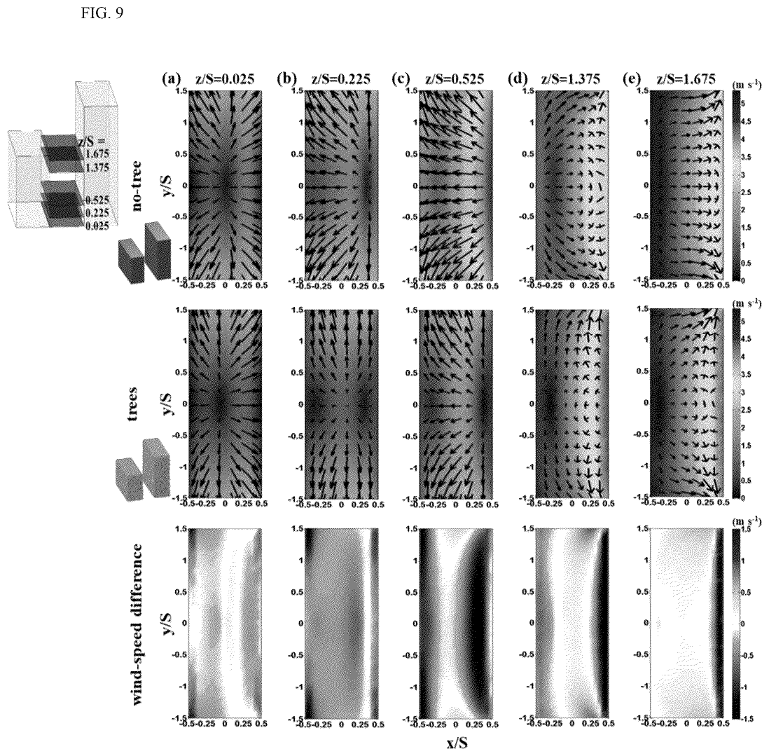

FIG. 9 is a diagram showing the wind field based on an altitude in each of the canyon of the building without trees and the canyon having the vertical forest building as analyzed using the system in FIG. 1.

Referring to FIG. 9, it may be identified that in the vertical forest building, the trees change the flow pattern significantly depending on a height in the step-up street canyon, compared to the buildings without trees. It may be identified that at z/S=0.025, 0.225 and 0.525, the divergence region changes toward the upwind building. Further, it may be identified that the flow out of the canyon has strengthened, but the countercurrent near the ground surface has weakened, resulting in a decrease in the wind speed. On the other hand, it may be identified that the flow out of the canyon is strengthened in the upper portion of the canyon (above z/S=1.375) due to change in the primary vortex.

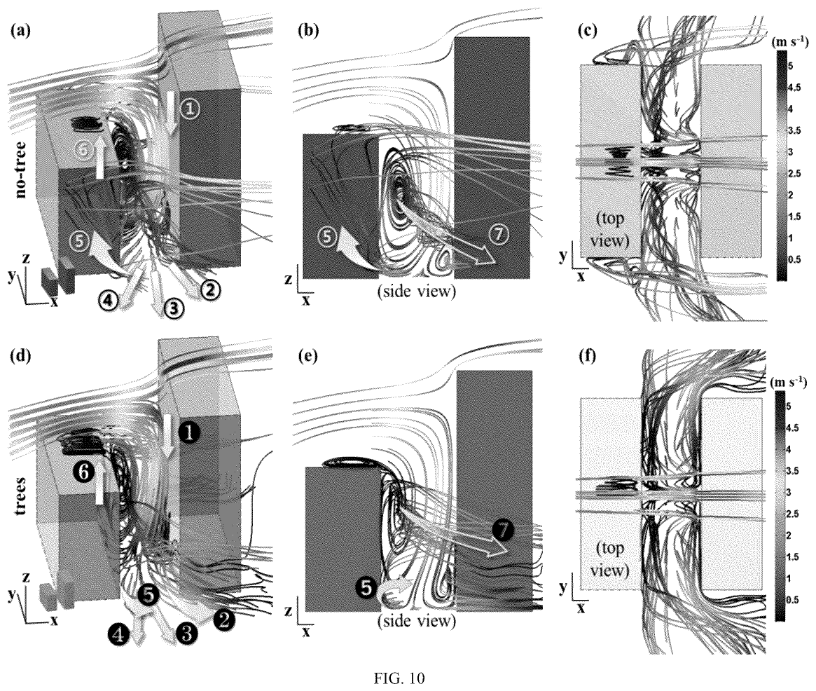

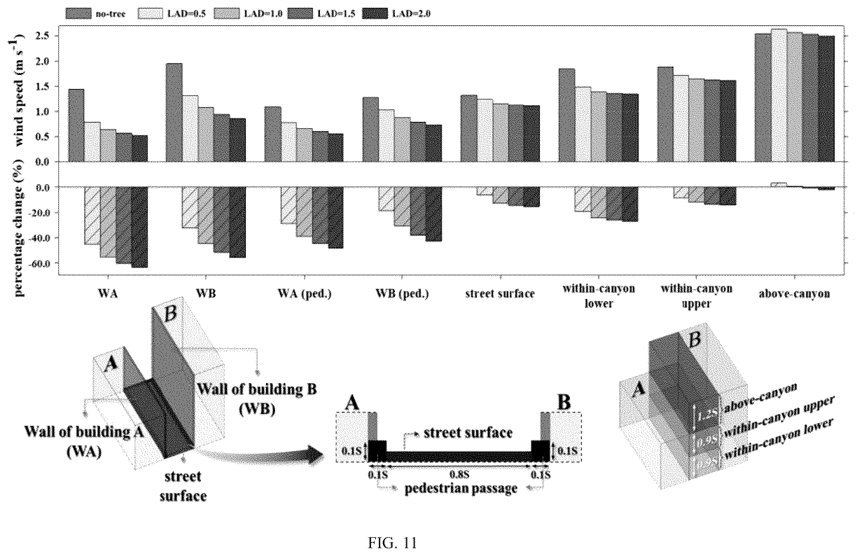

FIG. 10 is a diagram showing the three-dimensional streamline around each of a building without trees and a vertical forest building as analyzed using the system in FIG. 1.

The upper drawings in FIG. 10 show the results of analyzing the 3D streamlines on the step-up street canyon composed of buildings without trees, and the lower drawings in FIG. 10 show the results of analyzing the 3D streamlines on the step-up street canyon including a vertical forest planted with trees.

Referring to FIG. 10, it may be identified that the air flow of the upwind building collides with the wall surface of the downwind building, thereby generating downward air flow. It may be identified that near the ground surface, the atmospheric flow is divided, thereby creating a countercurrent and a flow out of the canyon, and the countercurrent generates a flow that rises along the upwind building. It may be identified that the vertical forest weakens the wind speed near buildings and significantly changes the structure and strength of the primary and secondary vortexes (the magnitude of the primary vortex becomes smaller, and the magnitude of the secondary vortex increases vertically). Furthermore, it may be identified that the air flow flowing out from the side surface of the canyon is weakened, and the strength of the rising flow on the upwind building wall surface is weakened.

FIG. 11 is a diagram showing a wind speed and a wind speed reduction percentage in each analysis target area under the leaf area density (LAD) scenario as analyzed using the system in FIG. 1.

FIG. 11 shows the results of analyzing the wind speed and the reduction percentage on the surface, the lower layer, and the upper layer of the canyon based on change (scenario) in the LAD value on the step-up street canyon including the vertical forest planted with trees. Referring to FIG. 11, it may be identified that the average wind speed decreases in proportion to the LAD. It may be identified that the wind speed reduction percentage is maximum on the upwind building wall surface (WA) and is minimum on the street surface. It may be identified that the wind speed within the canyon decreases by approximately 14 to 20%.

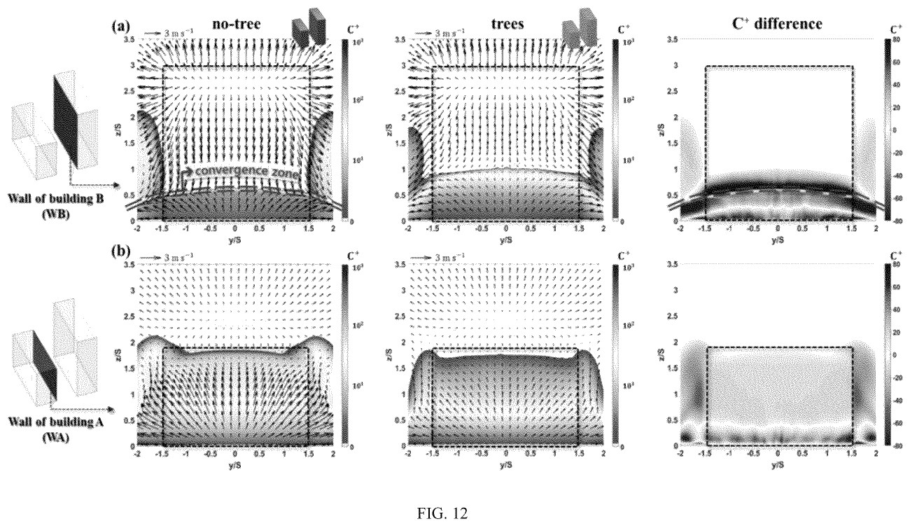

FIG. 12 is a diagram showing a non-dimensional concentration field on each of the upwind and downwind wall surfaces of each of the building without trees and the vertical forest building as analyzed using the system in FIG. 1.

FIG. 12 shows the dimensionless concentration field (a) on the downwind wall surface (WB) and the dimensionless concentration field (b) on the upwind wall surface (WA), respectively.

Referring to FIG. 12, it may be identified that in the step-up street canyon composed of buildings without trees, fine dust emitted from the ground surface due to the primary and secondary vortexes is transported to a location near the wall surface, and thus, the concentration of fine dust is high on the wall surface, and the concentration of the fine dust decreases as the altitude increases. It may be identified that on the downwind building wall surface, a sharp concentration gradient appears based on a point (convergence zone) at which downward air flow and upward air flow meet each other. It may be identified that on the upwind building wall surface, the fine dust is transported to the ceiling due to the rising flow of the primary vortex.

It may be identified that in the step-up street canyon including the vertical forest planted with trees, the convergence zone is shifted upward on the downwind wall surface (vertical growth of the secondary vortex), and the fine dust transport range also increases in the vertical direction. It may be identified that on the upwind building wall surface, the fine dust concentration increases near the ground surface (z/S≤0.5). It may be identified that when there is no tree, the fine dust particles are transported up to the ceiling due to recirculation on the upwind building wall surface (y/S≥|1.5|), whereas when there is a tree, the fine dust particles are not transported up to the ceiling height due to recirculation on the sidewall and weakened upward air flow, and its concentration relatively decreases.

FIG. 13 is a diagram showing the non-dimensional concentration field based on an altitude inside each of the canyon composed of the building without trees and the canyon having the vertical forest building as analyzed using the system in FIG. 1.

Referring to FIG. 13, it may be identified that the vertical forest significantly changes the distribution of the fine dusts, while an overall pattern thereof on the step-up street canyon including the vertical forest planted with trees an overall pattern thereof on the step-up street canyon composed of buildings without trees are similar to each other. It may be identified that the concentration of the fine dusts is high in areas close to the road (z/S=0.025) and near the ground surface (z/S=0.225), while under the presence of trees, the concentration thereof increases significantly due to decrease in the wind speed. It may be identified that the high concentration area near the downwind wall surface extends toward the center of the canyon due to the growth of the secondary vortex at z/S=0.525 altitude. It may be identified that when there is the tree, the concentration thereof decreases in the upper layer of the canyon (z/S=1.375, 1.675) even though the concentration thereof increases in the lower layer of the canyon. At z/S=0.025 and 0.225, the outward flow is enhanced by the vertical forest and thus the large amount of the fine dust particles is transported out of the canyon.

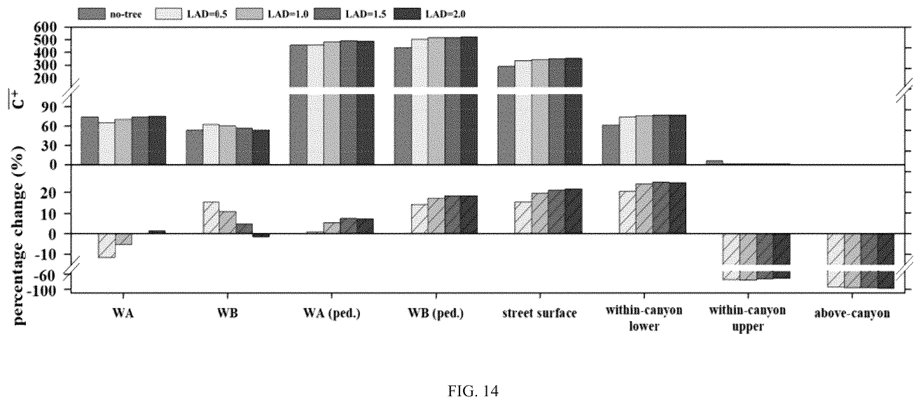

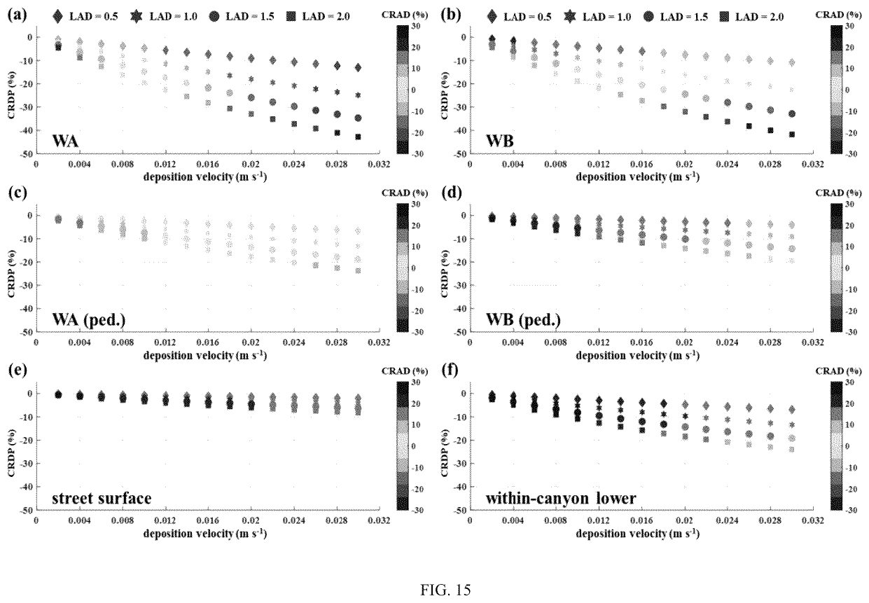

FIG. 14 is a diagram showing the dimensionless concentration and the concentration reduction percentage in each analysis target area based on the leaf area density (LAD) scenario as analyzed using the system in FIG. 1.

FIG. 14 shows the results of analyzing the dimensionless concentration C̅⁺̅ and the concentration reduction percentage of the surface, the lower layer, and the upper layer of the canyon based on change (scenario) in the LAD value on the step-up street canyon including the vertical forest planted with trees. Referring to FIG. 14, the influence of the LAD on the dimensionless concentration C̅⁺̅ averaged over eight areas of the step-up street canyon (WA, WB, WA and WB pedestrian walkway, ground surface, lower and upper layers within the canyon, and an area on top of the canyon) may be analyzed.

It may be identified that regardless of the leaf area density (LAD), the vertical forest increases the dimensionless concentration C̅⁺̅ in the pedestrian walkway near the upwind wall surface (WA) and the downwind wall surface (WB), on the road surface, and in the lower area of the canyon. This is because the average wind speed is inversely proportional to the LAD value. In the step-up street canyon including the vertical forest, the average wind speed in the lower layer of the canyon was in a range of 73 to 81% of that when there were no trees, and the dimensionless concentration C̅⁺̅ increased by 20 to 25% compared to when there were no trees. Further, on the downwind wall surface (WB), the dimensionless concentration C̅⁺̅ decreased as the LAD value increased. It may be identified that the increase in the LAD value results in the vertical growth of the secondary vortex, such that the diffusion range of the fine dust and the deposition range by the tree expand to increase the concentration reduction. The nonlinear combination of the tree drag and dry deposition results in non-monotonic fluctuation of the dimensionless concentration C̅⁺̅ along with increasing the LAD value.

FIG. 15 shows the concentration reduction percentage (CRDP) calculated based on only the deposition effect in each analysis target area under the leaf area density (LAD) scenario as analyzed using the system in FIG. 1, and the concentration reduction percentage (CRDP) calculated based on the deposition and drag effects in each analysis target area under the leaf area density (LAD) scenario as analyzed using the system in FIG. 1.

Referring to FIG. 15, the extent to which the vertical forest contributes to the reduction of the fine dust concentration in the step-up street canyon may be analyzed. For this purpose, additional analysis was performed using the system in FIG. 1 while increasing the deposition velocity (V_{d}) from 0.0 to 3.0 cm s⁻¹ by 0.2 cm s⁻¹. The CRDP (concentration rates changed by the deposition process) is an indicator that indicates the concentration reduction percentage depending on the presence or absence of the deposition effect. The CRAD (concentration rates changed by aerodynamic and deposition processes) is an indicator that indicates the concentration reduction percentage depending on the presence or absence of trees. It may be identified that the CRDP is inversely proportional to the LAD value while being in a range of from −42.7% on the upwind wall surface (WA) to −41.7% on the downwind wall surface (WB) (that is, as the LAD increases, the deposition effect increases). The CRAD has a negative value except for the deposition velocity being lower than 0.01 m s⁻¹ or LAD≤1.0 or 1.5 (this means that the concentration was reduced by the tree). The CRAD on the downwind wall surface (WB) has as a positive value when the CRDP is smaller than −17.4%. This means that the concentration decrease due to the deposition is more dominant than the concentration increase due to the decrease in the wind speed. The CRAD is always positive in the pedestrian passage and the ground surface of the downwind wall surface (WB), and in the lower layer of the canyon. This means that the increase in the fine dust concentration due to the aerodynamic process is always greater than the decrease in fine dust due to the deposition process.

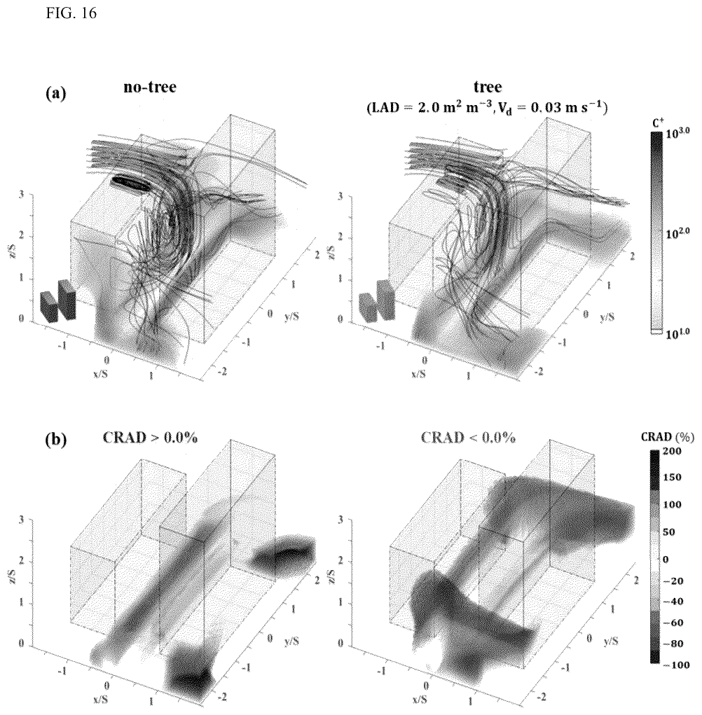

FIG. 16 shows the three-dimensional non-dimensional concentration field around the building without trees and the vertical forest building as analyzed using the system in FIG. 1, and the area where the concentration is improved (CRAD>0.0%) and the area where the concentration is deteriorated (CRAD<0.0%).

Referring to FIG. 16, it may be identified that the concentration of the fine dust is relatively low in the center of the canyon due to the descending air current. A portion of the fine dust moves to the downwind area along the portal and corner vortex, while the other thereof is partially transported to an area outside the canyon along the outward flow. It may be identified that the tree reduces the wind speed near the wall and within the canyon, and weakens the recirculation on the sidewall of the upwind building, and vertically increases the magnitude of the secondary vortex. The fine dust emitted from the road is transported to the both opposing wall surfaces of the building. It may be identified that when there is the tree, the fine dust is not transported upwardly along the side surface of the upwind building due to the weakened recirculation on the sidewall and escapes out of the canyon near the ground surface. It may be identified that despite the significant reduction of the fine dust due to the dry deposition and the direct transport thereof to the outside, the fine dust concentration in the lower layer of the canyon increases due to the reduced wind speed of the portal vortex. It is difficult to determine whether the vertical forest increases or decreases the fine dust concentration in the step-up street canyon, due to a nonlinear correlation between factors that promote increase (reduced wind speed) and decrease (dry deposition) in the fine dust concentration. However, based on the CRAD, intuitive inferences about the effect of the vertical forest on the fine dust concentration may be made. Based on the CRAD distribution, the tree mainly increased the fine dust concentration in the lower layer of the canyon and decreased the fine dust concentration in the upper layer of the canyon. This suggests that the vertical forest has the duality of increasing fine dust exposure at the pedestrian altitude, but reducing the fine dust in the upper layer and the surrounding area.

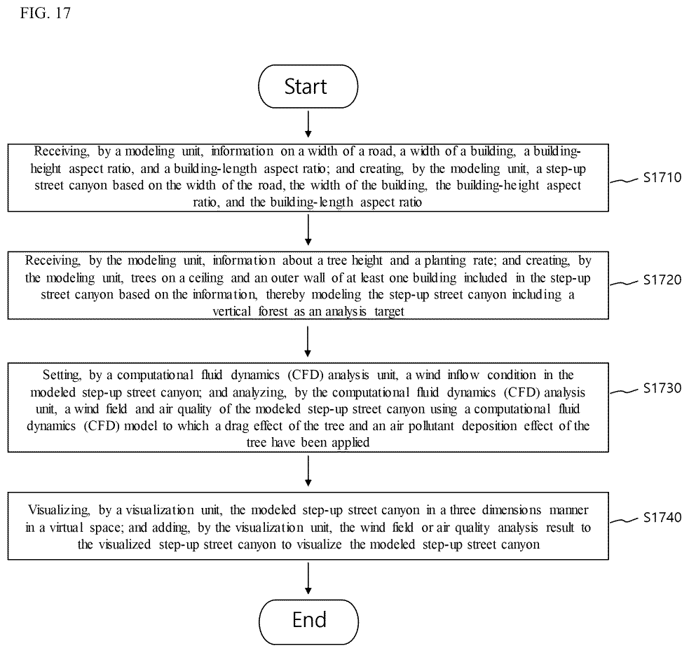

FIG. 17 is a flowchart for illustrating for analyzing air flow and air quality around a vertical forest using a computational fluid dynamics (CFD) model based on tree effect according to an embodiment of the present disclosure.

Referring to FIG. 17, the method includes receiving, by the modeling unit 110, information on a width of a road, a width of a building, a building-height aspect ratio, and a building-length aspect ratio; and creating, by the modeling unit 110, a step-up street canyon based on the width of the road, the width of the building, the building-height aspect ratio, and the building-length aspect ratio in S1710.

The method includes receiving, by the modeling unit 110, information about a tree height and a planting rate; and creating, by the modeling unit 110, trees on a ceiling and an outer wall of at least one building included in the step-up street canyon based on the information, thereby modeling the step-up street canyon including a vertical forest as an analysis target in S1720.

The method includes setting, by the computational fluid dynamics (CFD) analysis unit 120, a wind inflow condition in the modeled step-up street canyon; and analyzing, by the computational fluid dynamics (CFD) analysis unit 120, a wind field and air quality of the modeled step-up street canyon using a computational fluid dynamics (CFD) model to which a drag effect of the tree and an air pollutant deposition effect of the tree have been applied in S1730.

In one embodiment, analyzing, by the computational fluid dynamics (CFD) analysis unit 120, the wind field and air quality of the modeled step-up street canyon includes: numerically analyzing, by the computational fluid dynamics (CFD) analysis unit, the wind field based on a governing Equation of a CFD model of a RANS (Reynolds-Averaged Navier-Stokes Equation) model; and numerically analyzing, by the computational fluid dynamics (CFD) analysis unit, the air quality based on a pollutant transport Equation. Details thereof are as described above with reference to the system in FIG. 1.

The method includes visualizing, by the visualization unit 130, the modeled step-up street canyon in a three dimensions manner in a virtual space; and adding, by the visualization unit 130, the wind field or air quality analysis result to the visualized step-up street canyon to visualize the modeled step-up street canyon in S1740.

In one embodiment, the method further includes: applying, by the verification unit 140, the computational fluid dynamics (CFD) model to which an air pollutant deposition effect has been to a test model; and verifying, by the verification unit 140, the computational fluid dynamics (CFD) model based on application result.

The system and method for analyzing the air flow and air quality around the vertical forest using the computational fluid dynamics (CFD) model based on the tree effect as described above with reference to FIGS. 1 to 17 may also be implemented in the form of a recording medium containing instructions executable by a computer, such as applications or modules executed by the computer.

The computer-readable media may be any available media that may be accessed by a computer, including both volatile and nonvolatile media, removable and non-removable media. Furthermore, the computer-readable media may include both computer storage media and communication media. The computer storage media includes both volatile and non-volatile, removable and non-removable media implemented in any method or technology for storage of information such as computer-readable instructions, data structures, modules or other data. The communication media typically includes computer readable instructions, data structures, program modules, or other data in a modulated data signal, such as a carrier wave, or other transmission mechanism, and includes any information delivery medium.

The unit as used herein may refer to hardware that may perform a function and an operation according to each name described herein, or may also refer to a computer program code that may perform a specific function and operation, or may also refer to an electronic recording medium loaded with a computer program code that may perform a specific function and operation, such as a processor.

Although the embodiments of the present disclosure have been described above, the technical idea of the present disclosure is not limited to the above embodiments. Various embodiments of the system and method for analyzing the air flow and air quality around the vertical forest using the computational fluid dynamics (CFD) model based on the tree effect may be implemented within the scope of the technical idea of the present disclosure.

What is claimed is:

1. A system for analyzing air flow and air quality around a vertical forest using a computational fluid dynamics (CFD) model based on a tree effect, the system comprising:
a modeling unit configured to:
receive information on a width of a road, a width of a building, a building-height aspect ratio, and a building-length aspect ratio;
create a step-up street canyon based on the width of the road, the width of the building, the building-height aspect ratio, and the building-length aspect ratio;
to receive information about a tree height and a planting rate; and
create trees on a ceiling and an outer wall of at least one building included in the step-up street canyon based on the information, thereby modeling the step-up street canyon including a vertical forest as an analysis target;
a computational fluid dynamics (CFD) analysis unit configured to:
set a wind inflow condition in the modeled step-up street canyon; and
analyze a wind field and air quality of the modeled step-up street canyon using a computational fluid dynamics (CFD) model to which a drag effect of the tree and an air pollutant deposition effect of the tree have been applied; and
a visualization unit configured to:
visualize the modeled step-up street canyon in a three dimensions manner in a virtual space; and
add the wind field or air quality analysis result to the visualized step-up street canyon to visualize the modeled step-up street canyon.

2. The system of claim 1, wherein the modeling unit is configured to model a tree-free step-up street canyon in which trees are absent on a ceiling and an outer wall of a building,
wherein the computational fluid dynamics (CFD) analysis unit is configured to analyze a wind field and air quality on the tree-free step-up street canyon,
wherein the visualization unit is configured to visualize the wind field and air quality analysis results on the tree-free step-up street canyon and the wind field and air quality analysis results on the step-up street canyon including the vertical forest.

3. The system of claim 1, wherein the computational fluid dynamics (CFD) analysis unit is configured to:
numerically analyze the wind field based on a governing Equation of a CFD model of a RANS (Reynolds-Averaged Navier-Stokes Equation) model; and
numerically analyze the air quality based on a pollutant transport Equation.

4. The system of claim 3, wherein the computational fluid dynamics (CFD) analysis unit configured to numerically analyzes the wind field is further configured to calculate a momentum, turbulent kinetic energy (TKE) and a turbulence kinetic energy (TKE) dissipation rate, based on a tree drag parameterized based on a leaf drag coefficient (C_{d}) as a leaf surface roughness, and a leaf area density (LAD) as an area occupied with leaves per unit volume.

5. The system of claim 4, wherein the computational fluid dynamics (CFD) analysis unit is configured to calculate the momentum using a following Equation 4:
$${{\frac{{dU}_{i}}{dt} \vert}_{tree} = \frac{{dU}_{i}}{dt} \vert}_{org} - {n}_{2}^{3} \cdot {c}_{d} \cdot LAD \cdot {U}_{i} \cdot \vert U \vert \qquad [ Equation 4 ]$$
wherein the Equation 4 represents a relationship between a momentum Equation (tree) with a tree drag term and a momentum Equation (org) without a tree drag term,
where i is an integer, Uᵢ denote an i^{th} mean velocity component, ne denotes a fraction covered with a vertical projection of the leaves, Ca denotes the leaf drag coefficient as the leaf surface roughness of the tree, the LAD (Leaf Area Density) denotes an area size occupied with the leaves per unit volume, and |U| denotes a wind speed.

6. The system of claim 4, wherein the computational fluid dynamics (CFD) analysis unit is configured to calculates the turbulence kinetic energy (TKE) using a following Equation 9:
$${{\frac{dk}{dt} \vert}_{tree} = \frac{dk}{dt} \vert}_{org} + {n}_{2}^{3} {c}_{d} LAD {\vert U \vert}^{3} - 4 {n}_{c}^{3} {c}_{d} {LAD}_{k} \vert U \vert \qquad [ Equation 9 ]$$
wherein the Equation 9 represents a relationship between the turbulence kinetic energy (TKE) with the tree drag term added thereto and the turbulence kinetic energy (TKE) (org) without the tree drag term,
where K denote the turbulence kinetic energy (TKE), i is an integer, Uᵢ denote an i^{th} mean velocity component, n_{c} denotes a fraction covered with a vertical projection of the leaves, C_{d} denotes the leaf drag coefficient as the leaf surface roughness of the tree, the LAD (Leaf Area Density) denotes an area size occupied with the leaves per unit volume, and |U| denotes a wind speed.

7. The system of claim 4, wherein the computational fluid dynamics (CFD) analysis unit is configured to calculate the turbulence kinetic energy (TKE) dissipation rate using a following Equation 11:
$${{\frac{d ε}{dt} \vert}_{tree} = \frac{d ε}{dt} \vert}_{org} + \frac{3}{2} \frac{ε}{k} {n}_{c}^{3} {c}_{d} LAD {\vert U \vert}^{3} - 6 {n}_{c}^{3} {c}_{d} LAD ε \vert U \vert \qquad [ Equation 11 ]$$
wherein the Equation 11 expresses a relationship between the turbulence kinetic energy (TKE) dissipation rate (tree) with a tree drag term added thereto and the turbulence kinetic energy (TKE) dissipation rate (org) without the tree drag term,
where ε denotes the TKE dissipation rate, i is an integer, Uᵢ denote an i^{th} mean velocity component, n_{c} denotes a fraction covered with a vertical projection of the leaves, C_{d} denotes the leaf drag coefficient as the leaf surface roughness of the tree, the LAD (Leaf Area Density) denotes an area size occupied with the leaves per unit volume, and |U| denotes a wind speed.

8. The system of claim 3, wherein the computational fluid dynamics (CFD) analysis unit configured to numerically analyze the air quality is further configured to analyze the air quality by applying dry deposition in which air pollutant is deposited on the leaves of trees, using a following Equation 16:
$$\frac{\partial C}{\partial t} + {U}_{j} \frac{\partial C}{\partial t} = D \frac{{\partial }^{2} C}{\partial {x}_{j} \partial {x}_{j}} - \frac{\partial }{\partial {x}_{j}} ( \overline{c {𝓊}_{j}} ) - LAD \cdot {V}_{d} \cdot C . \qquad [ Equation 16 ]$$
where C denotes a mean concentration of a given pollutant species in air, D denotes a molecular diffusivity of the pollutant, and V_{d} denotes a dry deposition velocity,
wherein C and Uⱼ represent fluctuations from respective means of C and Uᵢ, respectively,
wherein −c̅u̅ⱼ̅ represents a turbulent flux of pollutants.

9. The system of claim 1, wherein the system further comprises a verification unit configured to:
apply the computational fluid dynamics (CFD) model to which an air pollutant deposition effect has been to a test model; and
verify the computational fluid dynamics (CFD) model based on application result.

10. The system of claim 9, wherein the test model is a wind-tunnel model.

11. A method for analyzing air flow and air quality around a vertical forest using a computational fluid dynamics (CFD) model based on a tree effect, the method comprising:
receiving, by a modeling unit, information on a width of a road, a width of a building, a building-height aspect ratio, and a building-length aspect ratio;
creating, by the modeling unit, a step-up street canyon based on the width of the road, the width of the building, the building-height aspect ratio, and the building-length aspect ratio;
receiving, by the modeling unit, information about a tree height and a planting rate;
creating, by the modeling unit, trees on a ceiling and an outer wall of at least one building included in the step-up street canyon based on the information, thereby modeling the step-up street canyon including a vertical forest as an analysis target;
setting, by a computational fluid dynamics (CFD) analysis unit, a wind inflow condition in the modeled step-up street canyon;
analyzing, by the computational fluid dynamics (CFD) analysis unit, a wind field and air quality of the modeled step-up street canyon using a computational fluid dynamics (CFD) model to which a drag effect of the tree and an air pollutant deposition effect of the tree have been applied;
visualizing, by a visualization unit, the modeled step-up street canyon in a three dimensions manner in a virtual space; and
adding, by the visualization unit, the wind field or air quality analysis result to the visualized step-up street canyon to visualize the modeled step-up street canyon.

12. The method of claim 11, wherein analyzing, by the computational fluid dynamics (CFD) analysis unit, the wind field and air quality of the modeled step-up street canyon includes:
numerically analyzing, by the computational fluid dynamics (CFD) analysis unit, the wind field based on a governing Equation of a CFD model of a RANS (Reynolds-Averaged Navier-Stokes Equation) model; and
numerically analyzing, by the computational fluid dynamics (CFD) analysis unit, the air quality based on a pollutant transport Equation.

13. The method of claim 11, wherein the method further comprises:
applying, by a verification unit, the computational fluid dynamics (CFD) model to which an air pollutant deposition effect has been to a test model; and
verifying, by the verification unit, the computational fluid dynamics (CFD) model based on application result.
